(19) United States
(12) Patent Application Publication
(10) Pub. No.: US 2015/0367596 A1
(43) Pub. Date: Dec. 24, 2015

(54) CARBON FIBER INSULATOR AND PREPARING METHOD THEREOF

(71) Applicant: OCI COMPANY LTD., Seoul (KR)

(72) Inventors: Kwang-Eui YOON, Seongnam-si (KR); Hyun-Chul LEE, Seongnam-si (KR); Jae-Heung PARK, Seongnam-si (KR); Hag-Cheon KIM, Seongnam-si (KR); Sung-Gyun KIM, Seongnam-si (KR)

(21) Appl. No.: 14/732,095

(22) Filed: Jun. 5, 2015

(30) Foreign Application Priority Data
Jun. 23, 2014 (KR) 10-2014-0076663

(51) Int. Cl. B32B 5/02; B32B 37/06; B32B 5/06

(52) U.S. Cl. CPC B32B 5/02; B32B 5/06; B32B 37/06; B32B 2262/106; B32B 2262/0253; B32B 2262/0284; B32B 2307/304; B32B 2305/72; B32B 2307/72; B32B 2309/02

(57) ABSTRACT

The present invention relates to a carbon fiber insulator and a producing method thereof. More specifically, the present invention relates to a carbon fiber insulator which is produced from a heterogeneous laminated felt comprising a carbon fiber mat laminate having at least one carbon fiber mat laminated therein and a low carbonization rate fiber mat provided at least one of upper and lower portions of the carbon fiber mat laminate.

### CROSS-REFERENCE TO RELATED APPLICATION

This application claims the benefit of Korean Patent Application No. 10-2014-0076663, filed on Jun. 23, 2014, entitled “CARBON FIBER INSULATOR AND PREPARING METHOD THEREOF”, which is hereby incorporated herein by reference in its entirety.

### TECHNICAL FIELD

The present invention relates to a carbon fiber insulator and a producing method thereof. More specifically, the present invention relates to a carbon fiber insulator which is produced from a heterogeneous laminated felt comprising a carbon fiber mat laminate having at least one carbon fiber mat laminated therein and a low carbonization rate fiber mat provided at least one of upper and lower portions of the carbon fiber mat laminate.

### BACKGROUND

A carbon material has high thermal & electrical conductivity, and an excellent mechanical strength, and has been widely used in various industrial fields. A carbon fiber, which is formed by processing the carbon material into a fibrous shape, refers to a material with a fibiform shape having carbon content not less than 90%, and has superb thermal conductivity, electrical conductivity, and mechanical property of matter.

The carbon fiber having a fibrous shape has high workability and wide applicability, and attracts particular interest among many carbon materials. The carbon fiber particularly has excellent properties at a high temperature, with the mechanical strength getting bigger as the temperature rises in contrast to metallic materials whose mechanical strength gets degraded at high temperatures, and is regarded as the only material which has a small coefficient of thermal expansion and can be used at a temperature up to 3000° C. in a non-oxidizing atmosphere.

Carbon fibers can be classified into a PAN-based carbon fiber, a rayon-based carbon fiber, and a pitch-based carbon fiber according to their raw materials. The PAN-based carbon fiber is relatively lighter than other materials, has a favorable mechanical property of matter, and therefore has been widely used in a high quality sports and leisure articles such as a golf club, a fishing rod, etc., and is currently regarded as a material to replace metal in a field where conventionally metal materials were used in a vehicle, a ship, etc. The rayon-based carbon fiber which prepared from inexpensive raw materials can be produced simply at a low cost. Therefore, the rayon-based carbon fiber can be produced in a massive amount, which enables the rayon-based carbon fiber to be used as a general purpose carbon fiber. The pitch-based carbon fiber is produced by using coal tar and petroleum residue oil as a raw material and classified into an isotropic carbon fiber and an anisotropic carbon fiber, and is widely used as a general purpose material and a specific functional material according to purposes and producing methods.

Particularly, the pitch-based carbon fiber is produced by using very cheap char coal tar and petroleum residue oil, and has various utility fields as industrial materials since it has a high modulus value and is hardly thermal-transformed at high temperatures. Also a desired property of matter can be obtained by changing a producing method thereof and is characterized by the fact that it can be widely utilized in a specific field as a functional material as well as general purpose carbon fibers.

Based on this property, a demand for the pitch-based carbon fiber is rapidly rises in industrial fields, which is especially true in a high temperature insulator field.

The high temperature insulator is a special industrial material which is used in a furnace with a temperature not lower than about 1500° C., and by now, the carbon fiber is the only material which can be used at the temperature not lower than 1500° C. The high temperature insulator is an essential material for producing semiconductors and polysilicons used in a photovoltaic field, and requires favorable heat insulation performance and highly pure property of matter, and an isotropic carbon fiber can be used as the source material.

In a method of producing a high temperature insulator, there is a method of dispersing a carbon fiber with a short length into a dispersion solvent and then impregnating a binder to form the insulator using a mold. The method of producing the insulator is a method of forming a carbon fiber insulator by dispersing a carbon fiber of 1-5 mm in a dispersion solvent such as water or alcohol, and has a drawback that dispersion does not easily occur and a large amount of dispersion solvent is required. In general, the carbon fiber exists in a twisted shape, and, therefore it is hard to disperse the carbon fiber using the dispersion solvent and, even when dispersion occurs, the dispersion effect is not favorable, which makes it difficult to obtain a high temperature insulator with excellent heat insulation properties.

Another way of producing the high temperature insulator uses a carbon fiber mat for producing the insulator. A spun carbon fiber is collected and deposited, and processes such as opening, carding, and needle punching are performed to produce the carbon fiber mat, and, then, the carbon fiber mat is impregnated in a binder to be laminated, pressurized, and cured to form the insulator (refer to FIG. 1). This is an effective way of producing the insulator since no separate dispersion process is required differently from aforementioned methods, but, when referring to FIGS. 1 and 2, a carbon fiber which is normal to a laminate surface of the carbon fiber mat is formed by the needle punching, and a heat radiation amount increases (heat insulation performance is degraded), which has made it hard to produce a insulator with excellent properties.

### SUMMARY OF THE INVENTION

It is an objective of the present invention to provide a carbon fiber insulator and a producing method thereof. Since a carbon fiber, which is normal to a laminate surface of a carbon fiber mat and formed by a needle punching, causes a heat radiation amount to be increased, it is the objective of the present invention to provide a carbon fiber insulator in which a fiber normal to a low carbonization rate fiber mat and a laminate surface is removed from a heterogeneous laminated felt including the low carbonization rate fiber mat at least one of upper and lower portions of the carbon fiber mat laminate having at least one carbon fiber mat laminated therein, and a method of producing the carbon fiber insulator.

In order to accomplish the technical problem as above, according to an aspect of the present invention, there can be provided a carbon fiber insulator which is produced by heat-treating a heterogeneous laminated felt comprising: a carbon fiber mat laminate having at least one carbon fiber mat laminated therein; and a low carbonization rate fiber mat provided at least one of upper and lower portions of the carbon fiber mat laminate, wherein the carbon fiber mat laminate and the low carbonization rate fiber mat are in a bound state by a needle punching in a thickness direction of the carbon fiber mat laminate.

According to another aspect of the present invention, there can be provided a method of producing a carbon fiber insulator, comprising: (a) preparing a homogeneous felt comprising a carbon fiber mat laminate having at least one carbon fiber mat laminated therein and a low carbonization rate fiber mat provided at least one of upper and lower portions of the carbon fiber mat laminate, wherein the carbon fiber mat laminate and the low carbonization rate fiber mat are in a bound state by a needle punching in a thickness direction of the carbon fiber mat laminate; (b) impregnating the heterogeneous laminated felt into a binder resin and curing the heterogeneous laminated felt; and (c) heat-treating the cured heterogeneous laminated felt to remove the low carbonization rate fiber mat from the heterogeneous laminated felt.

When the carbon fiber insulator is produced by using the heterogeneous laminated felt according to an embodiment of the present invention, a fiber, which is needle punched in a laminate direction (thickness direction) of the carbon fiber mat laminate having at least one carbon fiber mat laminated therein, can be removed, thereby solving a problem of insulation performance degradation due to an increase in a heat radiation amount

### BRIEF DESCRIPTION OF THE DRAWINGS

The above and other features and advantages of the present invention will become more apparent by describing in detail exemplary embodiments thereof with reference to the attached drawings in which:

FIG. 1 shows a method of producing a carbon fiber felt and a insulator according to a prior art;

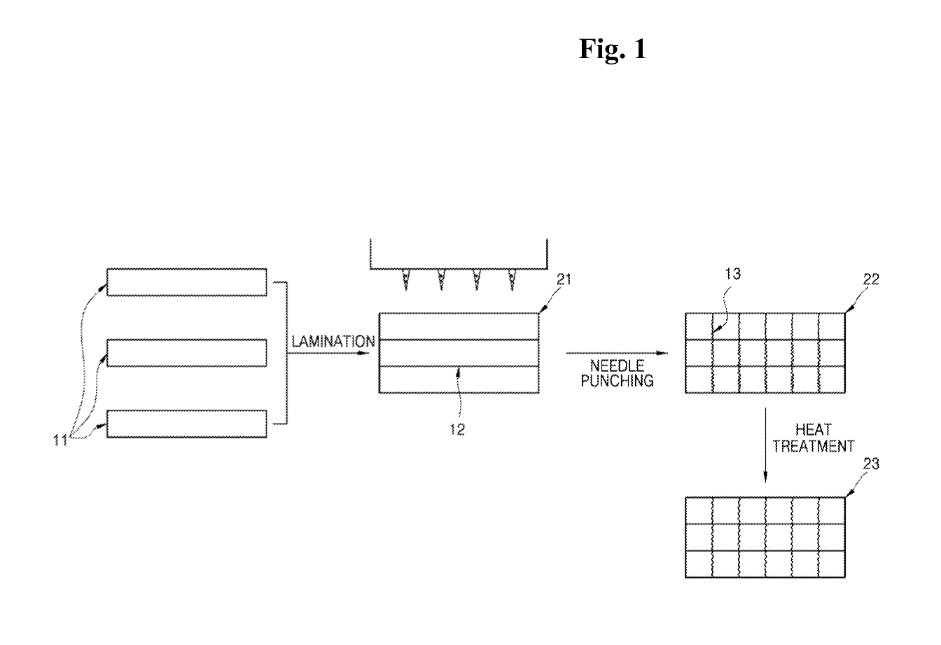

FIG. 2 shows a heat flow in the insulator according to the prior art;

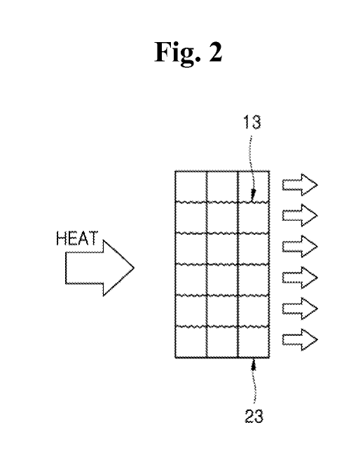

FIG. 3 shows a method of producing a heterogeneous laminated felt and a insulator according to an embodiment of the present invention; and

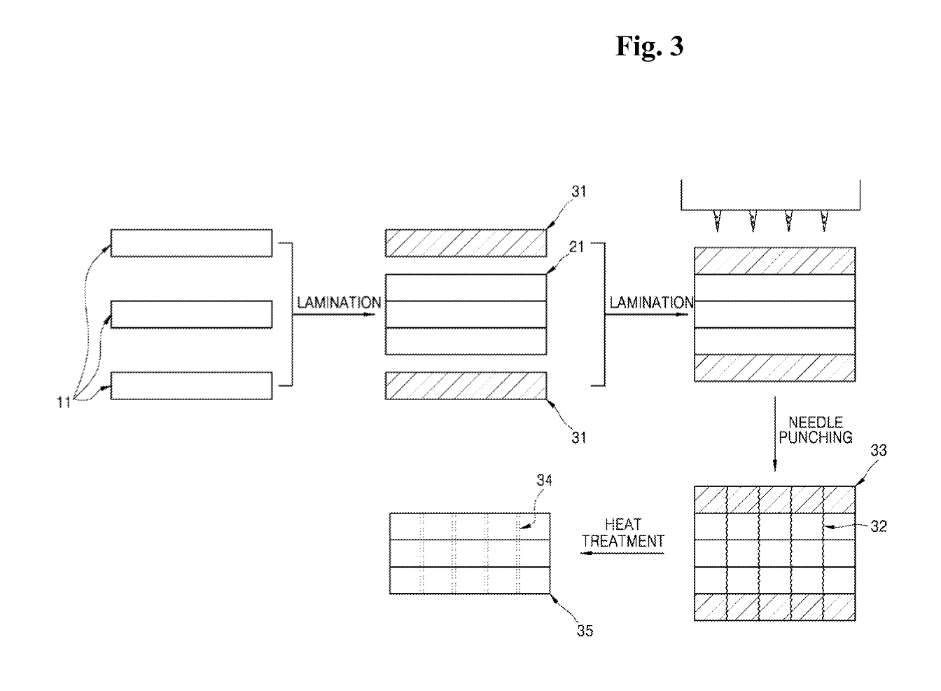

FIG. 4 shows a heat flow in the insulator according to an embodiment of the present invention.

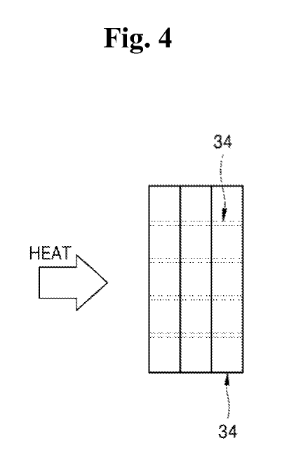

### DETAILED DESCRIPTION OF THE INVENTION

In order to ease understanding of the present invention, specific terms and expediently defined in the present application. Unless defined to the contrary, scientific terms and technical terms used in the present invention have meanings which are generally understood by those of ordinary skill in the art to which the present invention pertains. Also, unless specifically specified in the context, a term in a singular form is to be understood to include its plural form while a term in a plural form is to be understood to include its singular form.

Although terms including an ordinal number such as first, second, etc. can be used to describe various components, the components are not restricted by those terms. These terms are used only to discriminate one component from another.

According to another aspect of the present invention, there can be provided a carbon fiber insulator 35 which is produced by heat-treating a heterogeneous laminated felt 33 comprising: a carbon fiber mat laminate 21 having at least one carbon fiber mat 11 laminated therein; and a low carbonization rate fiber mat 31 provided at least one of upper and lower portions of the carbon fiber mat laminate 21, wherein the carbon fiber mat laminate 21 and the low carbonization rate fiber mat 31 are in a bound state by a needle punching in a thickness direction of the carbon fiber mat laminate.

The term “mat” used herein generally means a sheet-shaped material which is not bound by the needle punching, and the term “felt” used herein generally means a laminated type material which is bound by the needle punching.

Here, a thickness direction of the carbon fiber mat laminate 21 means an orientation normal to a carbon fiber mat laminate surface 12.

The carbon fiber mat 11 means a fiber mat from which elements other than carbon (for example, oxygen or hydrogen) are removed during a carbonization process such that no element other than carbon substantially remains in the carbon fiber mat, and in one embodiment, a bulk density of the carbon fiber mat can be 0.03-0.15 g/cm³.

On the other hand, the low carbonization rate fiber mat 31 means to a fiber mat where elements other than carbon (for example, oxygen or hydrogen) remain in the fiber mat. Here, the low carbonization rate fiber mat 31 can be replaced by materials with other shapes. For example, the low carbonization rate fiber mat 31 can be replaced by a felt in which a plurality of mats are laminated and used, or can be also used as a fiber other than a mat itself.

In one embodiment, the low carbonization rate fiber mat 31 can have a carbonization rate not higher than 10%, preferably lower than 5%, and more preferably lower than 3%. Here, the carbonization rate can be defined as a mass ratio of the low carbonization rate fiber mat remaining after the heat treatment. That is, after the heat treatment performed at a temperature selected from a range of 800-2,300° C. less than 5% of the original mass, which existed in an initial heterogeneous laminated felt, of the low carbonization rate fiber mat 31 can remain.

Thus, in the carbon fiber insulator 35 which is finally formed through the heat treatment, the low carbonization rate fiber mat 31 can remain by a ratio lower than 5% of the mass, which existed in an initial heterogeneous laminated felt, or preferably by a ratio lower than 3% of the mass, or more preferably, no low carbonization rate fiber mat 31 can substantially remain. When no low carbonization rate fiber mat 31 substantially remains after the heat treatment, the carbon fiber insulator 35 which is finally formed can be composed of only the carbon fiber mat laminate 21.

In one embodiment, the low carbonization rate fiber mat 31 can consist of at least one selected from polypropylene, polyethylene terephthalate, polyethylene, and biodegradable resin felt, but not is necessarily restricted to those elements.

Here, the needle punching is a forming method which binds or interlaces a plurality of layers of a fiber mat into one laminate, and a portion of fibers composing the fiber mat located at an upper portion and/or a lower portion of the fiber mat consisting of a plurality of layers is lowered or raised in a thickness direction (normal to the laminate surface) of the fiber mat laminate by the needle punching, such that the fiber mats located at the upper portion and/or lower portion are bound with a fiber mat which is interposed between them.

In one embodiment, in the heterogeneous laminated felt 33, the low carbonization rate fiber mat 31 is additionally laminated at the upper portion and/or lower portion of the carbon fiber mat laminate 21 on which at least one carbon fiber mat 11 is laminated, and the laminated carbon fiber mat laminate 21 is bound with the low carbonization rate fiber mat 31 by the needle punching.

When the low carbonization rate fiber mat 31 is located at the lower portion of the carbon fiber mat laminate 21, a portion of fibers 32 which composes the low carbonization rate fiber mat 31 is drawn upward in the thickness direction (normal to the laminate surface), such that the carbon fiber mat laminate 21 is bound with the low carbonization rate fiber mat 31.

When the low carbonization rate fiber mat 31 is located at the upper portion of the carbon fiber mat laminate 21, a portion of fibers 32 which composes the low carbonization rate fiber mat 31 is drawn downward in the thickness direction (normal to the laminate surface), such that the carbon fiber mat laminate 21 is bound with the low carbonization rate fiber mat 31.

That is, in the carbon fiber insulator consisting of a plurality of layers, an interface bonding between the layers is performed by a fiber in a thickness direction (normal to the laminate surface) of the laminate which is formed by the needle punching. Meanwhile, the fiber 32 in the thickness direction (normal to the laminate surface) of the laminate is regarded as a reason for increasing the thermal conductivity of the carbon fiber insulator. Therefore, in order to decrease the thermal conductivity of the carbon fiber insulator, the fiber 32 in the thickness direction (normal to the laminate surface) of the laminate is required to be removed after the interface bonding between the layers is sufficiently performed.

As described above, when using the heterogeneous laminated felt 33 according to an embodiment of the present invention, a portion of the fiber 32 which composes the low carbonization rate fiber mat 31 is drawn upward in the thickness direction (normal to the laminate surface), such that the carbon fiber mat laminate 21 is bound with the low carbonization rate fiber mat 31, and in the meantime, the fiber 32 which is drawn upward in the thickness direction (normal to the laminate surface) of the laminate preferably includes a low carbonization rate fiber, and more preferably, it can be a substantially low carbonization rate fiber. Here, the expression ‘substantially low carbonization rate fiber’ means that no fiber composing the carbon fiber mat is included in the fiber which is drawn upward in the thickness direction (normal to the laminate surface) of the laminate.

The low carbonization rate fiber 32 in the thickness direction of the carbon fiber mat laminate 21 can be removed by a heat treatment performed at a temperature selected from a range of 800-2,300° C. When the low carbonization rate fiber 32 removed by the heat treatment, a space which was previously possessed by the low carbonization rate fiber 32 in the thickness direction of the carbon fiber mat laminate 21 can be formed as a through hole 34.

According to another aspect of the present invention, there can be provided a method of producing a carbon fiber insulator 35 comprising: (a) preparing a homogeneous felt 33 comprising a carbon fiber mat laminate 21 having at least one carbon fiber mat 11 laminated therein; and a low carbonization rate fiber mat 31 provided at least one of upper and lower portions of the carbon fiber mat laminate 21, wherein the carbon fiber mat laminate 21 and the low carbonization rate fiber mat 31 are in a bound state by a needle punching in a thickness direction of the carbon fiber mat laminate 21; (b) impregnating the heterogeneous laminated felt 33 into a binder resin and curing the heterogeneous laminated felt 33; and (c) heat-treating the cured heterogeneous laminated felt 33 to remove the low carbonization rate fiber mat 31 from the heterogeneous laminated felt 33.

In one embodiment, in step (b), the carbon fiber mat laminate 21 and the low carbonization rate fiber mat 31 can be in a bound state by a low carbonization rate fiber 32 which is needle punched in a thickness direction of the carbon fiber mat laminate 21. Here, a thickness direction of the carbon fiber mat laminate 21 means an orientation normal to a carbon fiber mat laminate surface 12.

In one embodiment, the binder resin can be at least one selected from a phenol resin, a furan resin, an epoxy resin, a vinylester resin, a polyimide resin, and a pitch for impregnation.

The curing in step (c) can be performed by cutting the heterogeneous laminated felt 33 impregnated in the binder resin in a constant size and using a pressurization press. For example, the binder resin can be cured by applying a pressure for decreasing a thickness of the heterogeneous laminated felt 33 while maintaining a temperature at which the binder resin can be cured.

In one embodiment, the low carbonization rate fiber mat 31 can be removed by the heat treatment of step (c). Also, the low carbonization rate fiber 32 in the thickness direction of the carbon fiber mat laminate 21 can be removed by the heat treatment of step (c).

In one embodiment, mass retaining ratios of the low carbonization rate fiber mat 31 and the low carbonization rate fiber 32 in the thickness direction of the carbon fiber mat laminate 21 after the heat treatment of step (c) can be lower than 5%.

Therefore, in the carbon fiber insulator 35 which is finally formed through the heat treatment of step (c), the low carbonization rate fiber mat 31 can remain by a ratio lower than 5% with respect to an initial mass, or preferably by a ratio lower than 3% of the mass, or more preferably, no low carbonization rate fiber mat 31 can substantially remain. Also, in the carbon fiber insulator 35 which is finally formed through the heat treatment of step (c), the low carbonization rate fiber 32 in the thickness direction of the carbon fiber mat laminate 21 can remain by a ratio lower than 5% with respect to an initial mass, or preferably by a ratio lower than 3% of the mass, or more preferably, no low carbonization rate fiber 32 in the thickness direction of the carbon fiber mat laminate 21 can substantially remain.

In one embodiment, the heat treatment of step (c) can be performed at a temperature selected from a range of 800-2,300° C. In one embodiment, in the step (c), a first heat-treatment at a temperature selected from a range of 800-1,500° C. and a second heat-treatment at a temperature selected from a range of 1700-2300° C. can be sequentially performed.

Here, the first heat treatment is a carbonization process, while the second heat treatment is a graphitization process. During the first heat treatment degreased gas, and then, no pyrolysis gas is generated during the second heat treatment process.

Hereinafter, the present invention will be described in more detail using embodiments. Here, these embodiments are provided only to illustrate the present invention, and the scope of the present invention is not to be deemed to be restricted by these embodiments.

### EMBODIMENTS

### Method of Producing a Heterogeneous Laminated Felt for Producing a Carbon Fiber Insulator

A carbon fiber was spun by applying a melt-blow spinning method on a coal-based high softening point isotropic pitch (softening point: 28° C. The spun pitch-based carbon fiber was deposited to form a mat. The carbon fiber mat was transferred to a, non-compatibilization furnace and a carbonization furnace to produce a carbon fiber mat of 0.05 g/cm³. Also, a polypropylene felt was laminated on upper and lower portions of the carbon fiber mat and then a needle punching was performed to produce a heterogeneous laminated felt for producing a carbon fiber insulator.

### Method of Producing Carbon Fiber Insulator

The heterogeneous laminated felt which was produced according to the above embodiment was impregnated in a phenol resin, laminated to have 6 layers, and the result was pressurized to be cured. The pressure-cured carbon fiber mat was carbonized at a nitrogen atmosphere at 1,000° C. A bulk density of the carbonized carbon fiber insulator was 0.16 g/cm³, and all polypropylene felt, which was included in the heterogeneous laminated felt, was removed.

### Comparative Example

A carbon fiber insulator was produced at the same conditions as the embodiment except that only carbon fiber mats other than a low carbonization rate fiber mat such as a polypropylene mat were laminated. A fiber in the thickness direction of the carbon fiber mat laminate was not removed from the carbon fiber insulator according to the comparative example during the carbonization process.

Tensile strengths and peeling strengths according to the embodiment and the comparative example are as listed in table 1.

TABLE 1

| | low carbonization | tensile strength | peeling strength |
|---|---|---|---|
| | rate fiber felt used | (N/5 cm) | (N/5 cm) |
| EMBODIMENT | ◯ | 15 | 2.5 |
| Comparative | X | 10 | 1.5 |
| example | | | |

### Experimental Results

In order to measure thermal conductivities of carbon fiber insulators produced by the embodiment and the comparative example, samples of respective carbon fiber insulators were formed with a thickness of 30 mm, and the thermal conductivities were measured at 25° C. respectively. And in the meantime, a variation of the thermal conductivity at heat treatment temperatures ((800° C. and 1,000° C.) were also checked. Measurement results of the thermal conductivities are listed in Table 2.

TABLE 2

| | | mass | |
|---|---|---|---|
| | | retaining | |
| | | ratio (%) | |
| | | of low | thermal |
| | | carbonization | conductivity |
| | carbonization | rate | (W/m · K, |
| | temperature (° C.) | fiber mat | 25° C.) |
| EMBODIMENT 1 | 800 | <5 | 0.065 |
| EMBODIMENT 2 | 1,000 | <1 | 0.058 |
| Comparative | 1,000 | 0 | 0.084 |
| example | | | |

Under all of the conditions same as the embodiments, the carbon fiber insulator according to the comparative example produced by laminating only carbon fiber mats other than a low carbonization rate fiber mat such as a polypropylene mat naturally does not include the low carbonization rate fiber mat, therefore the mass retaining ratio of the low carbonization rate fiber mat was not measured. The thermal conductivity by the comparative example is 0.084, which is significantly greater than the thermal conductivities of the carbon fiber insulators according to the embodiment 1 and embodiment 2.

On the other hand, it could be acknowledged that the mass retaining ratio and thermal conductivity of the low carbonization rate fiber mat are varied according to the carbonization temperature. More specifically, as the carbonization temperature rises, the mass retaining ratio of the low carbonization rate fiber mat in the carbon fiber insulator, which is finally formed, is increased, and a removal ratio of the low carbonization rate fiber, which is oriented in the thickness direction of the carbon fiber insulator, is also increased, thereby decreasing a heat radiation amount in the thickness direction of a laminate of the carbon fiber insulator.

Therefore, According to the present invention, there is provided a carbon fiber insulator, wherein the low carbonization rate fiber, which was needle punched in the thickness direction of the low carbonization rate fiber mat and the carbon fiber mat laminate, was substantially removed from the heterogeneous laminated felt, thereby improving thermal insulation performance of the final carbon fiber insulator.

While the present invention has been particularly described with reference to an embodiment of the present invention, those of ordinary skill in the to which the present invention pertains can readily modify and alter the present invention in various ways by appending, changing, deleting, or adding components without departing from the spirit of the present invention as defined by the following claims, which are also deemed to fall in the scope of the present invention.

### EXPLANATION ON SYMBOLS

11: CARBON FIBER MAT
12: CARBON FIBER MAT LAMINATE SURFACE
13: CARBON FIBER
21: CARBON FIBER MAT LAMINATE
22: BOUND CARBON FIBER MAT LAMINATE
23: CARBON FIBER INSULATOR
31: LOW CARBONIZATION RATE FIBER MAT
32: LOW CARBONIZATION RATE FIBER
33: BOUND HETEROGENEOUS LAMINATED FELT
34: THROUGH HOLE
35: CARBON FIBER INSULATOR

What is claimed is:

1. A carbon fiber insulator which is produced by heat-treating a heterogeneous laminated felt comprising: a carbon fiber mat laminate having at least one carbon fiber mat laminated therein; and a low carbonization rate fiber mat provided at least one of upper and lower portions of the carbon fiber mat laminate, wherein the carbon fiber mat laminate and the low carbonization rate fiber mat are in a bound state by a needle punching in a thickness direction of the carbon fiber mat laminate.

2. The carbon fiber insulator according to claim 1, wherein the low carbonization rate fiber mat is characterized in having a carbonization rate not greater than 10%.

3. The carbon fiber insulator according to claim 2, wherein:
the low carbonization rate fiber mat is characterized in comprising at least one selected from polypropylene, polyethylene terephthalate, polyethylene, and biodegradable resin felt.

4. The carbon fiber insulator according to claim 1, wherein:
the low carbonization rate fiber mat is characterized in being removed through the heat-treatment.

5. The carbon fiber insulator according to claim 1, wherein:
the heat-treatment is characterized in being performed at a temperature selected from a range between 800-2,300° C.

6. The carbon fiber insulator according to claim 4, wherein:
a mass retaining ratio of the low carbonization rate fiber mat after the heat-treatment is characterized in being lower than 5%.

7. The carbon fiber insulator according to claim 1, wherein:
the carbon fiber mat laminate and the low carbonization rate fiber mat are characterized in being in the bound state by a low carbonization rate fiber which is needle punched in a thickness direction of the carbon fiber mat laminate.

8. The carbon fiber insulator according to claim 7, wherein:
the low carbonization rate fiber in the thickness direction of the carbon fiber mat laminate is characterized in being removed through the heat-treatment.

9. The carbon fiber insulator according to claim 8, wherein:
a mass retaining ratio of the low carbonization rate fiber in the thickness direction of the carbon fiber mat laminate after the heat-treatment is characterized in being lower than 5%.

10. The carbon fiber insulator according to claim 1, wherein:
a thermal conductivity in the thickness direction of the carbon fiber insulator is characterized in being lower than 0.06 (W/m·K, 25° C.).

11. A method of producing a carbon fiber insulator comprising:
(a) preparing a homogeneous felt comprising a carbon fiber mat laminate having at least one carbon fiber mat laminated therein and a low carbonization rate fiber mat provided at least one of upper and lower portions of the carbon fiber mat laminate, wherein the carbon fiber mat laminate and the low carbonization rate fiber mat are in a bound state by a needle punching in a thickness direction of the carbon fiber mat laminate;
(b) impregnating the heterogeneous laminated felt into a binder resin and curing the heterogeneous laminated felt; and
(c) heat-treating the cured heterogeneous laminated felt to remove the low carbonization rate fiber mat from the heterogeneous laminated felt.

12. The method of producing a carbon fiber insulator according to claim 11, wherein:
in the step (b), the carbon fiber mat laminate and the low carbonization rate fiber mat are characterized in being in the bound state by a low carbonization rate fiber which is needle punched in a thickness direction of the carbon fiber mat laminate.

13. The method of producing a carbon fiber insulator according to claim 12, wherein:
the low carbonization rate fiber in the thickness direction of the carbon fiber mat laminate is characterized in being removed through the heat-treatment in step (c).

14. The method of producing a carbon fiber insulator according to claim 11, wherein:
the binder resin is characterized in being at least one selected from a phenol resin, a furan resin, an epoxy resin, a vinylester resin, a polyimide resin, and a pitch for impregnation.

15. The method of producing a carbon fiber insulator according to claim 11, wherein:
a mass retaining ratio of the low carbonization rate fiber mat after the heat-treatment of step (c) is characterized in being lower than 5%.

16. The method of producing a carbon fiber insulator according to claim 11, characterized in that:
in the step (c), a first heat-treatment at a temperature selected from a range of 800-1,000° C. and a second heat-treatment at a temperature selected from a range of 1700-2300° C. are sequentially performed.

17. The method of producing a carbon fiber insulator according to claim 11, wherein:
a bulk density of the carbon fiber insulator is characterized in being 0.1-0.3 g/cm³.
